(19) United States
(12) Patent Application Publication
(10) Pub. No.: US 2022/0252004 A1
(43) Pub. Date: Aug. 11, 2022

(54) RADIAL PRE-DETONATOR

(71) Applicant: Detonation Space Inc., Hollywood, CA (US)

(72) Inventors: Ümit Yelken, Istanbul (TR); Mehmet Emre Taskin, Istanbul (TR)

(21) Appl. No.: 17/172,019

(22) Filed: Feb. 9, 2021

(51) Int. Cl. F02C 5/10; F02C 7/264

(52) U.S. Cl. CPC F02C 5/10; F02C 7/264

(57) ABSTRACT

A rotating detonation engine can include an annular combustion chamber, a fuel feed line, an oxidizer feed line, one or more igniters configured to detonate fuel and oxidizer reactants, a nozzle proximate the outlet of the annular combustion chamber, and a pre-detonation tube configured to provide the fuel and oxidizer reactants fed from the fuel feed line and the oxidizer feed line to the one or more detonators. The pre-detonation tube can have an outer surface, an inner surface, an inner diameter defining an internal flow region, an inlet proximate the fuel feed line and oxidizer feed line, and an outlet proximate the annular combustion chamber, and can defines a radial geometry that curves around the exterior of the annular combustion chamber.

### TECHNICAL FIELD

The present disclosure relates generally to combustion engines, and more particularly to rotating detonation engines having continuous thrust.

### BACKGROUND

Detonation engines are based on pressure gain combustion where shockwaves increase pressure and temperature on a fuel/air mixture during a combustion process. Common detonation engine types include pulse detonation engines and rotating detonation engines. Pulse detonation engines involve ongoing combustion impulses that are interrupted, which is limiting since a single detonation wave is essentially an isolated or “frozen” event for practical purposes. Rotating detonation engines, however, provide continuous thrust due to the combustion impulses for these engines being effectively continuous in an ongoing detonation wave.

Rotating detonation engines typically have an annulus shaped combustion chamber, operate at supersonic speeds, and provide continuous thrust at high operating frequencies of over 1000 Hz due to rapid sequential propagating detonation. Reactants are continuously fed into a rotating detonation combustion chamber from inlets, whereupon detonators ignite the reactants to result in a continuously circulating detonation wave around the annulus of the combustion chamber. Unfortunately, existing geometries for rotating detonation engine systems limit their applications. For example, detonation waves originate in straight reactant feed pipes, which prevents existing engines from being used where space is at a premium, such as in rockets and spacecraft. Straight reactant feed pipe usage also tends to result in lower efficiencies with respect to creating turbulence in the reactant feeds prior to detonation.

Although traditional detonation engines have worked well in the past, improvements are always helpful. In particular, what is desired are improved rotating detonation engines that provide continuous thrust from a reactant mixture feed that instigates increased reactant turbulence in a compact amount of space.

### SUMMARY

It is an advantage of the present disclosure to provide improved rotating detonation engines that have continuous thrust from a reactant mixture feed that instigates increased reactant turbulence in a compact amount of space. The disclosed features, apparatuses, systems, and methods provide rotating detonation engine solutions that involve improvements to pre-detonation components. These advantages can be accomplished in multiple ways, such as by curving a pre-detonation tube around the outside of an combustion chamber, as well as forming protrusions along the inner walls of the pre-detonation tube.

In various embodiments of the present disclosure, a rotating detonation engine can include an annular combustion chamber, a fuel feed line, an oxidizer feed line, one or more pre-detonators, a nozzle, and a pre-detonation tube. The annular combustion chamber can be configured for the repetitive high frequency combustion of fuel and oxidizer reactants, and can include an internal region, an exterior, an inlet and an outlet. The fuel feed line can be configured to feed fuel from a fuel source and the oxidizer feed line can be configured to feed fuel from an oxidizer source. The one or more detonators can be configured to detonate the fuel and oxidizer reactants, and the nozzle can be proximate the outlet of the annular combustion chamber. The pre-detonation tube can be configured to provide the fuel and oxidizer reactants fed from the fuel feed line and the oxidizer feed line to the annular combustion chamber, and can have an outer surface, an inner surface, an inner diameter defining an internal flow region, an inlet proximate the fuel feed line and oxidizer feed line, and an outlet proximate the annular combustion chamber. The pre-detonation tube can define a radial geometry that curves around at least a portion of the exterior of the annular combustion chamber.

In various detailed embodiments, the pre-detonation tube can include a plurality of obstacles along its inner surface, and these obstacles can facilitate turbulence in the fuel and oxidizer reactants flowing therethrough. The obstacles can include multiple protrusions that extend from the inner surface into the internal flow region. In various arrangements, the distance between each of the obstacles can be between about half of the inner diameter of the pre-detonation tube and about twice the inner diameter of the pre-detonation tube. The plurality of obstacles can result in a blockage ratio in the pre-detonation tube of about 0.3. In various embodiments, none of the obstacles are formed along about the first 25% of the pre-detonation tube length from the oxidizer and fuel feeds into the pre-detonation tube or along about the last 40% of the pre-detonation tube length before any of the one or more detonators. In some embodiments, the cross-section of the pre-detonation tube defines a square, rectangular, or circular shape, and in some embodiments the pre-detonation tube can have a length of about 216 mm and an inner diameter of about 10 mm. In various arrangements, the nozzle can define an aerospike shape. In addition, at least a portion of the fuel feed line can form an outer regenerative cooling line that wraps around the exterior and/or interior of the annular combustion chamber to cool the annular combustion chamber with fuel flowing through the outer regenerative cooling line.

In various further embodiments of the present disclosure, a pre-detonation tube can include an inlet configured to receive fuel from a separate fuel feed line and oxidizer from a separate oxidizer feed line, an outlet configured to provide fuel and oxidizer reactants into an annular combustion chamber, and a hollow interior defining an inner surface and an internal flow region configured to pass the fuel and oxidizer reactants therethrough. The pre-detonation tube can define a radial geometry that curves around at least a portion of the exterior of the separate annular combustion chamber.

In various detailed embodiments, the annular combustion chamber can form a portion of a rotating detonation engine and can be configured for the repetitive high frequency combustion of fuel and oxidizer reactants. In various arrangements, the pre-detonation tube can have a plurality of obstacles along the inner surface, and these obstacles can facilitate turbulence in the fuel and oxidizer reactants flowing therethrough. The distance between each of the obstacles can be between about half of the inner diameter of the pre-detonation tube and about twice the inner diameter of the pre-detonation tube. In various embodiments, none of the obstacles are formed along about the first 25% of the pre-detonation tube length from the inlet or along about the last 40% of the pre-detonation tube length before the outlet. In addition, the cross-section of the pre-detonation tube can define a square or rectangular shape, and the pre-detonation tube can have a length of about 216 mm and a diameter of about 10 mm.

In still further embodiments of the present disclosure, a combustion engine can include a combustion chamber, one or more detonators, and a pre-detonation tube. The combustion chamber can be configured for the combustion of fuel and oxidizer reactants and can include an internal region, an exterior, an inlet and an outlet. The one or more detonators can be configured to detonate the fuel and oxidizer reactants. The pre-detonation tube can be configured to provide the fuel and oxidizer reactants into the combustion chamber and can have an outer surface, an inner surface, an inner diameter defining an internal flow region, an inlet, and an outlet proximate the combustion chamber. The pre-detonation tube can define a geometry that curves around at least a portion of the exterior of the combustion chamber.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for rotating detonation engines having radial pre-detonation tubes. These drawings in no way limit any changes in form and detail that may be made to the disclosure by one skilled in the art without departing from the spirit and scope of the disclosure.

FIG. 1 illustrates in front perspective view an example rotating detonation engine having a radial pre-detonation tube according to one embodiment of the present disclosure.

FIG. 2 illustrates in side elevation view the example rotating detonation engine of FIG. 1 according to one embodiment of the present disclosure.

FIG. 3 illustrates in top cross-section view the example rotating detonation engine of FIG. 1 according to one embodiment of the present disclosure.

FIG. 4A illustrates in front perspective view an outer portion of an example regenerative cooling line for a rotating detonation engine having a radial pre-detonation tube according to one embodiment of the present disclosure.

FIG. 4B illustrates in front perspective view an inner portion of an example regenerative cooling line for a rotating detonation engine having a radial pre-detonation tube according to one embodiment of the present disclosure.

FIG. 5A illustrates in top plan view an example radial pre-detonation tube for a rotating detonation engine according to one embodiment of the present disclosure.

FIG. 5B illustrates in side elevation view the example radial pre-detonation tube of FIG. 5A according to one embodiment of the present disclosure.

FIG. 5C illustrates in top cross-section view the example radial pre-detonation tube of FIG. 5A according to one embodiment of the present disclosure.

FIG. 6A illustrates in front perspective view an example nozzle for a rotating detonation engine having a radial pre-detonation tube according to one embodiment of the present disclosure.

FIG. 6B illustrates in side cross-section view the example nozzle of FIG. 6B according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for providing and using improved rotating detonation engines. In particular, the disclosed embodiments provide improved geometries for the pre-detonation portions of rotating detonation engines that are advantageous in several respects. Rather than using straight reactant feed pipes, the disclosed pre-detonation tube can be radial or annular shaped such that it wraps around at least a portion of the engine combustion chamber. This advantageously reduces the amount of space required for the overall engine while also increasing the level of turbulence in the reactant flows. In addition, various protrusions and obstacles can be strategically formed along the inner wall of the pre-detonation tube so as to further increase turbulence in the reactant flow.

In various embodiments of the present disclosure, fuel and oxidizer as a mixture or through different feed lines can be fed into a pre-detonation tube having a radial geometry, which pre-detonation tube can also be referred to as a “shock tube.” An igniter near the feed line(s) then ignites the reactants, and a resulting combustion wave accelerates inside the pre-detonation tube and exits the tube in detonation mode at a combustion chamber inlet, thus starting or continuing a rotating detonation engine cycle.

Although various embodiments disclosed herein discuss rotating detonation engines, it will be readily appreciated that the disclosed features, apparatuses, systems, and methods can similarly be used for any relevant combustion engine having a radial reactant feed tube. For example, the disclosed radial geometry tube may also be used for pulse detonation engines, gas turbine combustion chambers, and other combustion engines. Alternative dimensions, shapes, cross-sections, and internal obstacle patterns may also be used for such radial reactant feed tubes. Other applications, arrangements, and extrapolations beyond the illustrated embodiments are also contemplated.

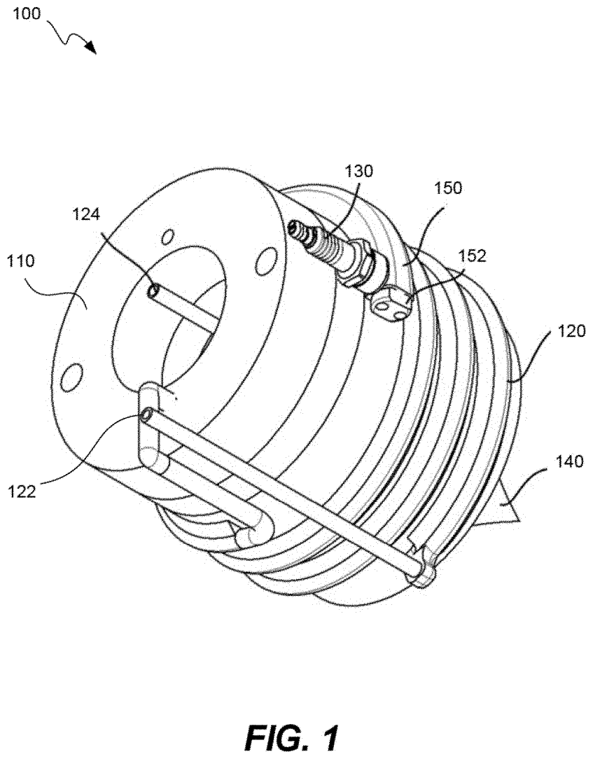

Referring first to FIG. 1, an example rotating detonation engine having a radial pre-detonation tube is illustrated in front perspective view. Rotating detonation engine 100 can include a combustion chamber 110, regenerative cooling lines 120, at least one igniter 130, a nozzle 140, and a radial pre-detonation tube 150. Reactants (e.g., fuel and oxidizer) can be fed from fuel and oxidizer sources (not shown) into the inlets 122, 124 of regenerative cooling lines 120, which can wrap around the outer and/or inner surfaces of the combustion chamber 110. Fuel and oxidizer can initially be introduced at cool temperatures, such that regenerative cooling lines 120 effectively cool the combustion chamber 110 during continuous operation thereof. Alternatively, separate coolant can be circulated through regenerative cooling lines 120, and fuel and oxidizer can be fed into pre-detonation tube 150 directly and separately from being used in the regenerative cooling lines 120.

In various embodiments, regenerative cooling lines 120 function both to cool the combustion chamber 110 and also to provide feed lines for the fuel and oxidizer. A wide variety of elements or compounds can be used as fuel and oxidizer, and the fuel to oxidizer ratio may be varied as desired. Both the fuel and the oxidizer can be in gas or liquid form. Fuel/oxidizer combinations can include, for example, kerosene/oxygen, hydrogen/oxygen, methanol/oxygen, and the like. Other fuels can include ethanol and paraffin. At the end of the regenerative cooling feed lines 120, the oxidizer and fuel can be fed into a radial pre-detonation tube 150 at an end plug 152 having one or more inlets into the tube. The fuel and oxidizer and reactant combination can be fed into the radial pre-detonation tube 150 premixed, which can take place at some location prior to end plug 152, or without being mixed, such that separate feed lines enter the radial pre-detonation tube 150 at end plug 152.

One or more igniters 130 can be located proximate the inlet end plug 152 of radial pre-detonation tube 150, and these igniter(s) can facilitate the ignition of the reactants and formation of a continuous detonation wave as the reactants exit the radial pre-detonation tube 150 and enter the combustion chamber 110 inside rotating detonation engine 100. Igniter 130 can be a spark igniter, such as a spark plug, as one form of ignition starter, and is will be readily appreciated that other types of igniters or ignition starters may also be used. Alternatively, a spark igniter might not be used in favor of alternative energy releasing technologies that can be used to ignite the reactants at the deflagration stage. Such alternative ignition starters or igniters can include, for example, ignition wires, flame sprayers, or pyrotechnic materials, among other possible igniters.

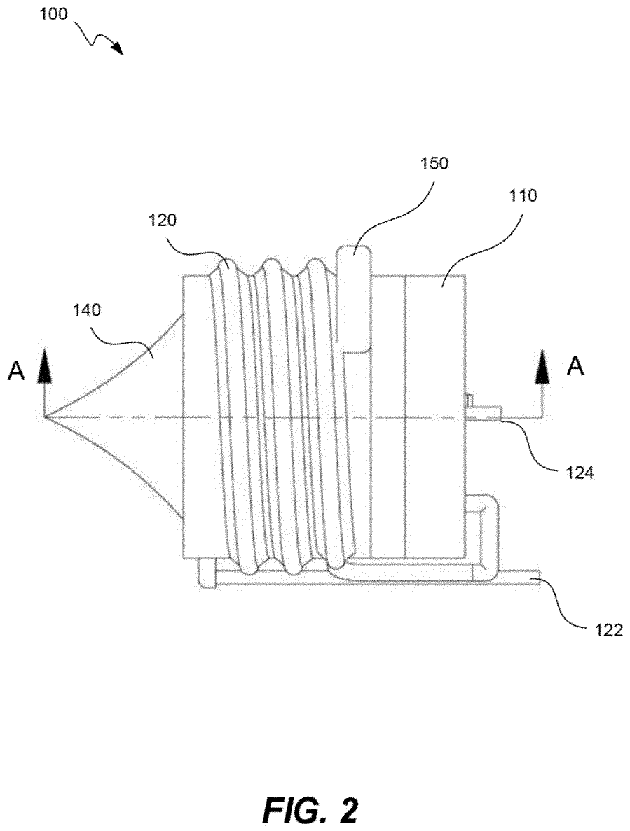

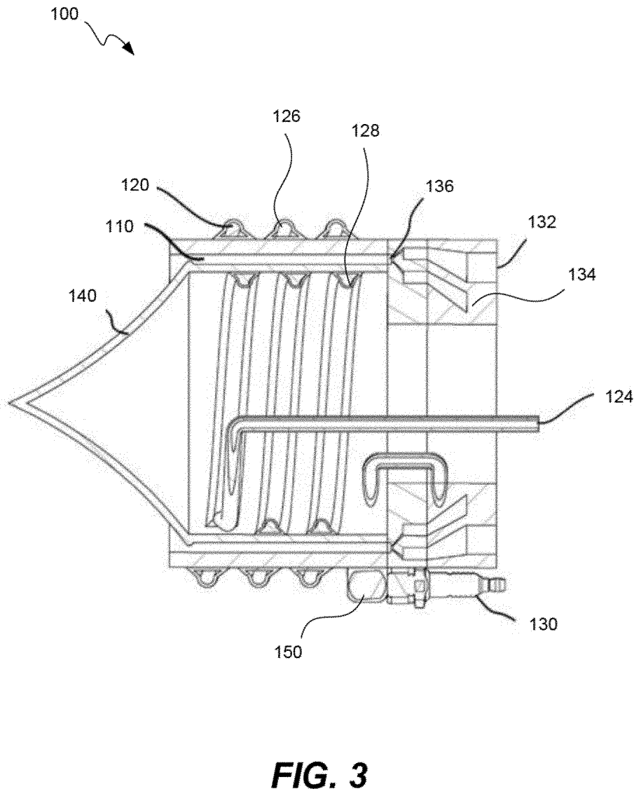

Continuing with FIGS. 2 and 3, the example rotating detonation engine of FIG. 1 is shown in side elevation and top cross-section views respectively. FIG. 2 is similar to FIG. 1 in that it depicts rotating detonation engine 100 from a purely external point of view. FIG. 3 is a cross-section taken at AA as denoted in FIG. 2. Again, rotating detonation engine can include a combustion chamber 110, one or more regenerative cooling lines 120 having inlet 122 and outlet 124, a nozzle 140, and a radial pre-detonation tube 150 that curves around at least a portion of the combustion chamber 110.

Fuel feed line 132 and oxidizer feed line 134 can end at one or more injectors 136 that inject the fuel and oxidizer into an inlet of the radial pre-detonation tube 150. The injector angle at which fuel and oxidizer are injected into the combustion chamber and the diameter of the injector may vary as desired. Fuel and oxidizer can be mixed together in a turbulent flow within the radial pre-detonation tube 150 before entering the combustion chamber 100. The level of mixing can depend upon the length of the pre-detonation tube and the obstacles located therein, as set forth in greater detail below. Alternatively, the fuel and oxidizer can be transferred unmixed into the combustion chamber where it is then ignited.

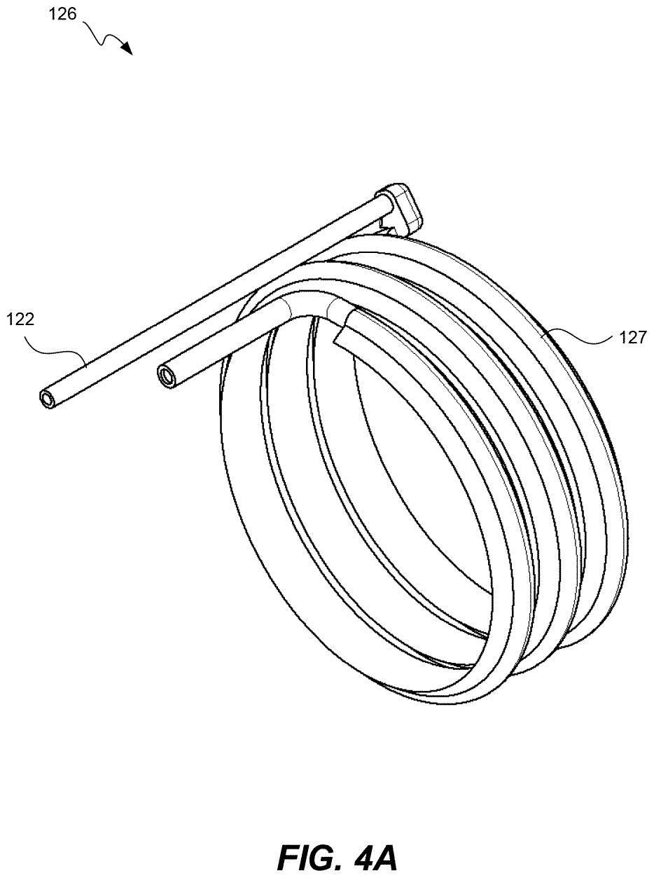

Transitioning now to FIG. 4A, an outer portion of an example regenerative cooling line for a rotating detonation engine having a radial pre-detonation tube is illustrated in front perspective view. Regenerative cooling line outer portion 126 can include an inlet 122, after which the cooling line wraps around the outer wall of the combustion chamber (not shown) in a spiral shape. A bracket or fastening component 127 can be used to hold the regenerative cooling line outer portion 126 steady or affix it to the outer wall of the combustion chamber. Welds may also be used to hold the line in place. The number of rotations in regenerative cooling line outer portion 126 may vary as desired. This number of rotations and the total length of the inner cooling line can depend on the fuel/oxidizer used and its flowrate.

Continuing with FIG. 4B, an inner portion of an example regenerative cooling line for a rotating detonation engine having a radial pre-detonation tube is shown in front perspective view. Regenerative cooling line inner portion 128 can include an inlet 124, after which the cooling line wraps around the inner wall of the combustion chamber (not shown) in a spiral shape. A bracket or fastening component 129 can be used to hold the regenerative cooling line inner portion 128 steady or affix it to the inner wall of the combustion chamber. Welds may also be used to hold the line in place. The number of rotations in regenerative cooling line inner portion 128 may vary as desired. This number of rotations and the total length of the inner cooling line can depend on the fuel/oxidizer used and its flowrate.

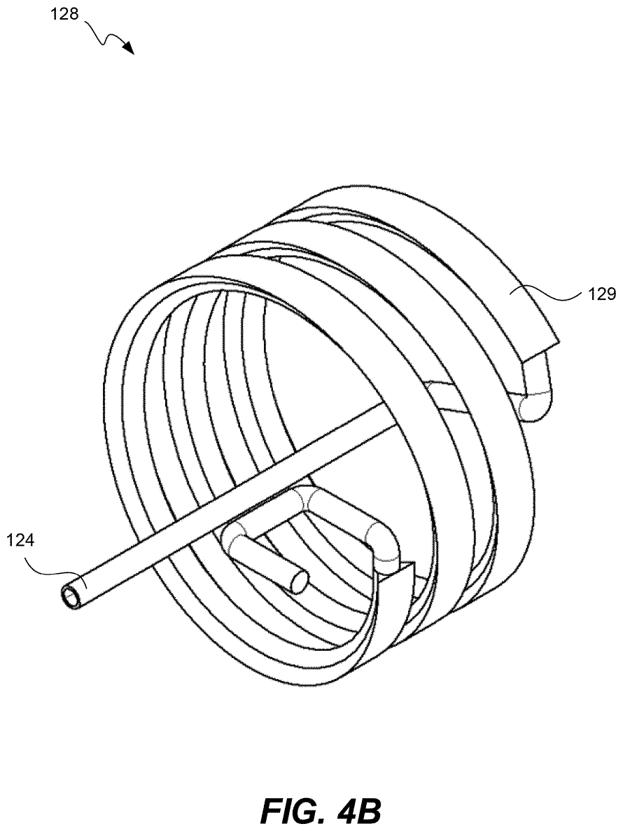

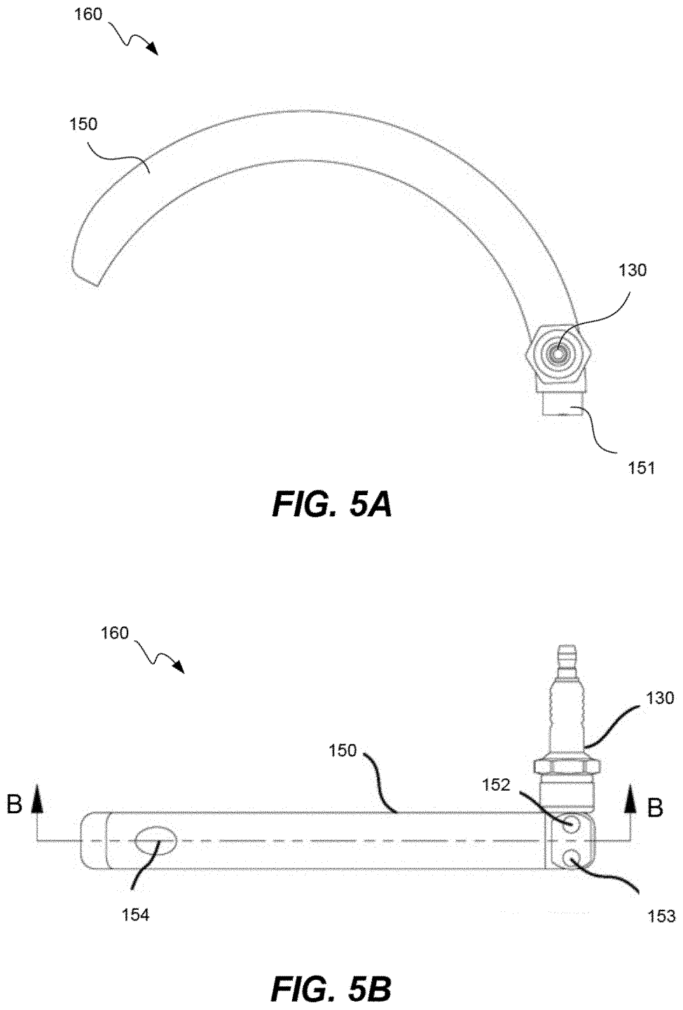

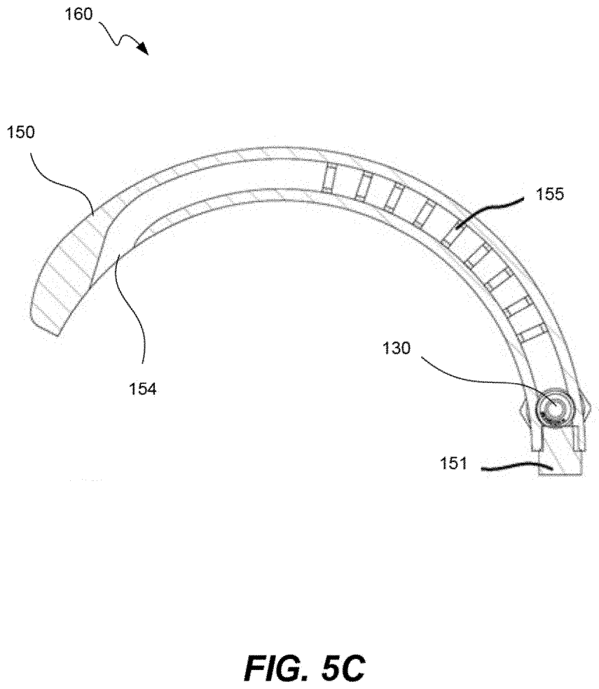

Moving next to FIGS. 5A and 5B, an example radial pre-detonator for a rotating detonation engine is illustrated in top plan and side elevation views respectively. Pre-detonator 160 can include a pre-detonation tube 150 and a feed line plug 151 at the front end of the tube proximate igniter 130. Feed line plug 151 can have a fuel inlet 152 where fuel is fed into the pre-detonation tube 150 and an oxidizer inlet 153 where oxidizer is fed into the pre-detonation tube 150. Multiple fuel and/or oxidizer inlets may be used in various designs. An outlet 154 at the back end of pre-detonation tube 150 can provide the fuel and oxidizer into the main combustion chamber of the engine (not shown).

Pre-detonation tube 150 can function to place a detonation wave of reactants into the combustion chamber of the engine. In various embodiments, pre-detonation tube 150 can have a radial geometry such that it curves around the exterior of the combustion chamber, which results in a more compact engine design that conserves space and allows the overall engine to be used in applications where space is at a premium, such as rockets and spacecraft.

In operation, fuel and oxidizer feeds can be input into feed line plug 151, where a spark igniter 130 or other ignition component can transfer sufficient heat to the fuel and oxidizer reactants. If more than one detonation is desired from the combustion chamber, the spark igniter 130 can be fired more than once. After ignition, the reactant flow turns from deflagration to detonation since the pre-detonation tube 150 is curved, resulting in enhanced turbulence. Increased turbulence and flow acceleration can also take place within pre-detonation tube 150 due to obstacles or protrusions located along the inner walls of the tube, as described in greater detail with respect to FIG. 5C below. The pre-detonation tube then places a detonation wave of ignited reactants into the combustion chamber just past its outlet 154.

In various embodiments, pre-detonation tube 150 can have a length of about 216 mm, an inner diameter of about 10 mm, and the tube can curve in a circular shape having a diameter of about 182 mm. Of course, other lengths, sizes, and shapes are also possible. In various embodiments, the geometry of the pre-detonation tube can be fully curved or annulus shaped. Alternatively, a portion of the pre-detonation tube can be curved or annulus shaped while another portion the pre-detonation tube can be arranged axially or straight. In addition, the internal flow region need not have a circular cross-section in all arrangements. In fact, square, rectangular, and other alternative cross-sections such are also possible.

FIG. 5C illustrates in top cross-section view the example radial pre-detonator 160 of FIGS. 5A and 5B. FIG. 5C is a cross-section taken at BB as denoted in FIG. 5B, and effectively represents a full pre-detonator system. Again, pre-detonation tube 150 can have a spark igniter 130, a feed line plug 151 configured to accept fuel and oxidizer inlet feeds, and an outlet 154 configured to deliver a detonation wave of the fuel and oxidizer reactants into the combustion chamber of the engine. In addition, one or more obstacles 155 can be formed along the inner walls or surfaces of the pre-detonation tube 150. Obstacles 155 can effectively form a piecemeal barrier within the inner fluid flow region that disrupts fluid flow and increases turbulence and flow acceleration. The shape and number of obstacles 155 within the pre-detonation tube 150 can vary, and these obstacles can essentially function to increase the turbulence and acceleration of the reactant flow mixture.

In some arrangements, obstacles 155 can form multiple protrusions that extend from the inner surface into the internal flow region of the pre-detonation tube 150. These obstacles or protrusions 155 can be added onto the inner surface or wall of the tube, or the pre-detonation tube 150 can have the obstacles integrally formed as part of the inner surface of tube. Through extensive research and development, it has been determined that a suitable blockage ration through the flow region of the pre-detonation tube 150 can be about 0.3, which provides significant added turbulence and acceleration to the fluids flowing therethrough.

In various embodiments the minimum distance between obstacles 155 can be about half the inner diameter of the hollow flow region, and the maximum distance between obstacles 155 can be about twice the inner diameter of the hollow flow region of the pre-detonation tube 150. In various arrangements it can be preferable not to have obstacles 155 near the start or the end of the pre-detonation tube 150 in order for reactant flows to be smooth at the start and the end of the tube. For example, the first 25% of the tube after the fuel and oxidizer inlets 151 can be free of obstacles 155, and the last 40% of the tube before the outlet 154 can also be free of obstacles, as shown. These percentages can vary as desired depending on the fuel used, the oxidizer used, and the desired flow rates.

In various alternative embodiments, other forms of flow disturbance and blockage can be placed within the pre-detonation tube 150. For example, a spring of a suitable diameter can be placed within the pre-detonation tube 150 to provide similar results with respect to increasing turbulence and fluid acceleration through the tube. Such a spring or other obstacle can be a single item that may take the form of a Schelkin spiral, for example, which can be placed within the pre-detonation tube 150 as a single obstacle rather than a plurality of obstacles.

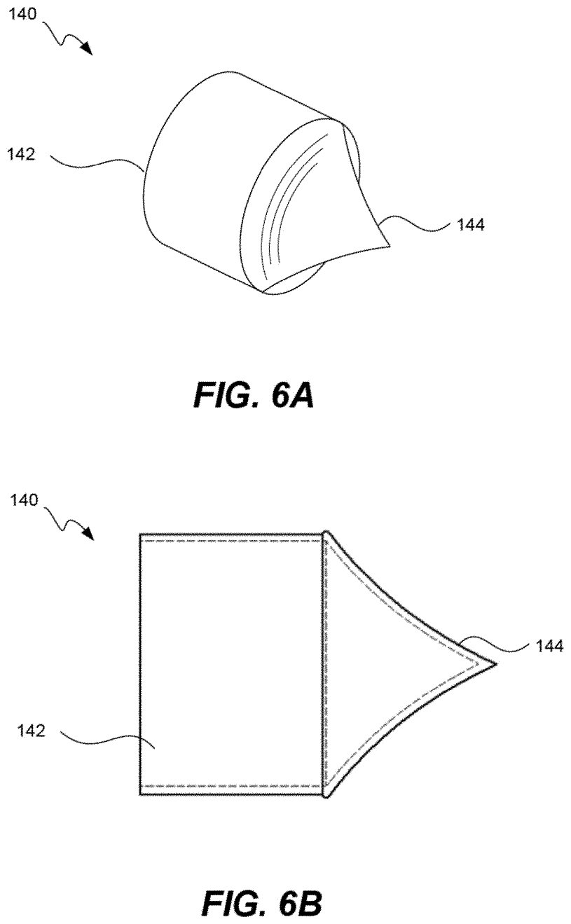

FIGS. 6A and 6B illustrate in front perspective and side cross-section views respectively an example nozzle for a rotating detonation engine having a radial pre-detonation tube. As noted above, nozzle 140 can be located proximate an outlet or exhaust of the combustion chamber of a combustion engine, such as a rotating detonation engine. In various embodiments, nozzle 140 can have an aerospike shape. The aerospike curve of nozzle 140 can be adjusted according to the reference flight altitude of the overall engine. Nozzle 140 can be integrally formed as a single unit or may be formed from multiple parts that are joined by welds, screws, or other fasteners. Depending on the intended pressure value of the operating engine, the size and shape of nozzle 140 may be altered. In some embodiments an aerospike nozzle may not be used, with other suitable nozzle types include a plug nozzle or a convergent-divergent nozzle.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A rotating detonation engine, comprising:
an annular combustion chamber configured for the repetitive high frequency combustion of fuel and oxidizer reactants, wherein the annular combustion chamber includes an internal region, an exterior, an inlet and an outlet;
a fuel feed line configured to feed fuel from a fuel source;
an oxidizer feed line configured to feed fuel from an oxidizer source;
one or more igniters configured to detonate the fuel and oxidizer reactants;
a nozzle proximate the outlet of the annular combustion chamber; and
a pre-detonation tube configured to provide the fuel and oxidizer reactants fed from the fuel feed line and the oxidizer feed line to the annular combustion chamber, the pre-detonation tube having an outer surface, an inner surface, an inner diameter defining an internal flow region, an inlet proximate the fuel feed line and oxidizer feed line, and an outlet proximate the annular combustion chamber, wherein the pre-detonation tube defines a radial geometry that curves around at least a portion of the exterior of the annular combustion chamber.

2. The rotating detonation engine of claim 1, wherein the nozzle defines an aerospike shape.

3. The rotating detonation engine of claim 1, wherein the pre-detonation tube includes a plurality of obstacles along its inner surface, the plurality of obstacles facilitating turbulence in the fuel and oxidizer reactants flowing therethrough.

4. The rotating detonation engine of claim 3, wherein the plurality of obstacles includes multiple protrusions that extend from the inner surface into the internal flow region.

5. The rotating detonation engine of claim 3, wherein the distance between each of the plurality of obstacles is between about half of the inner diameter of the pre-detonation tube and about twice the inner diameter of the pre-detonation tube.

6. The rotating detonation engine of claim 3, wherein the plurality of obstacles results in a blockage ratio in the pre-detonation tube of about 0.3.

7. The rotating detonation engine of claim 3, wherein none of the plurality of obstacles are formed along about the first 25% of the pre-detonation tube length from the oxidizer and fuel feeds into the pre-detonation tube.

8. The rotating detonation engine of claim 3, wherein none of the plurality of obstacles are formed along about the last 40% of the pre-detonation tube length before any of the one or more detonators.

9. The rotating detonation engine of claim 1, wherein the cross-section of the pre-detonation tube defines a square, rectangular, or circular shape.

10. The rotating detonation engine of claim 1, wherein the pre-detonation tube has a length of about 216 mm and an inner diameter of about 10 mm.

11. The rotating detonation engine of claim 1, wherein at least a portion of the fuel feed line forms an outer regenerative cooling line that wraps around the exterior of the annular combustion chamber to cool the annular combustion chamber with fuel flowing through the outer regenerative cooling line.

12. The rotating detonation engine of claim 1, wherein at least a portion of the fuel feed line forms an inner regenerative cooling line that wraps around the interior of the annular combustion chamber to cool the annular combustion chamber with fuel flowing through the inner regenerative cooling line.

13. A pre-detonation tube, comprising:
an inlet configured to receive fuel from a separate fuel feed line and oxidizer from a separate oxidizer feed line;
an outlet configured to provide fuel and oxidizer reactants into an annular combustion chamber; and
a hollow interior defining an inner surface and an internal flow region configured to pass the fuel and oxidizer reactants therethrough, wherein the pre-detonation tube defines a radial geometry that curves around at least a portion of the exterior of the separate annular combustion chamber.

14. The pre-detonation tube of claim 13, wherein the annular combustion chamber forms a portion of a rotating detonation engine and is configured for the repetitive high frequency combustion of fuel and oxidizer reactants.

15. The pre-detonation tube of claim 13, further comprising:
a plurality of obstacles along the inner surface, the plurality of obstacles facilitating turbulence in the fuel and oxidizer reactants flowing therethrough.

16. The pre-detonation tube of claim 15, wherein the distance between each of the plurality of obstacles is between about half of the inner diameter of the pre-detonation tube and about twice the inner diameter of the pre-detonation tube.

17. The pre-detonation tube of claim 15, wherein none of the plurality of obstacles are formed along about the first 25% of the pre-detonation tube length from the inlet or along about the last 40% of the pre-detonation tube length before the outlet.

18. The pre-detonation tube of claim 13, wherein the cross-section of the pre-detonation tube defines a square, rectangular, or circular shape.

19. The pre-detonation tube of claim 13, wherein the pre-detonation tube has a length of about 216 mm and a diameter of about 10 mm.

20. A combustion engine, comprising:
A combustion chamber configured for the combustion of fuel and oxidizer reactants, wherein the combustion chamber includes an internal region, an exterior, an inlet and an outlet;
one or more detonators configured to detonate the fuel and oxidizer reactants; and
a pre-detonation tube configured to provide the fuel and oxidizer reactants into the combustion chamber, the pre-detonation tube having an outer surface, an inner surface, an inner diameter defining an internal flow region, an inlet, and an outlet proximate the combustion chamber, wherein the pre-detonation tube defines a geometry that curves around at least a portion of the exterior of the combustion chamber.
